(19) United States
(12) Patent Application Publication
(10) Pub. No.: US 2024/0322427 A1
(43) Pub. Date: Sep. 26, 2024

(54) APPARATUSES AND METHODOLOGY INVOLVING ELECTROMAGNETIC METAMATERIALS

(71) Applicant: The Board of Trustees of the Leland Stanford Junior University, Stanford, CA (US)

(72) Inventors: Jonathan Fan, Los Altos, CA (US); Lucia Gan, Stanford, CA (US); Qinglan Huang, Stanford, CA (US); Jiaqi Jiang, Stanford, CA (US)

(21) Appl. No.: 18/290,090

(22) PCT Filed: May 13, 2022
(86) PCT No.: PCT/US2022/029286

§ 371 Date: Nov. 9, 2023

Related U.S. Application Data
(60) Provisional application No. 63/188,711, filed on May 14, 2021.

(51) Int. Cl. H01Q 3/46; B33Y 80/00; G06F 30/10; G06F 113/10

(52) U.S. Cl. CPC H01Q 3/46; B33Y 80/00; G06F 30/10; G06F 2113/10

(57) ABSTRACT

In certain examples, methods and optically-engineered structures involve three-dimensional (3D) or volumetric metamaterials, having a grayscale dielectric profile, to produce a certain electromagnetic response. In more specific examples, the 3D metamaterial may be implemented to approximate a grayscale continuum of dielectric constants, and may conform to curved and/or irregular shapes for use in a wide variety of applications such as electromagnetic devices wherein to operate via communication of radiating waves to be steered and/or manipulated as a function of frequency.

### FEDERALLY-SPONSORED RESEARCH AND DEVELOPMENT

This invention was made with Government support under N00014-20-1-2105 awarded by the Office of Naval Research. The Government has certain rights in the invention.

### BACKGROUND

Exemplary aspects of various embodiments are directed to optically-based apparatuses (e.g., systems, subsystems, devices, etc.) and methodology using volumetric electromagnetic metamaterials systems and methods of use and of manufacture including but not limited to the examples disclosed and/or illustrated herein.

It has been appreciated that current methods for providing control and direction over electromagnetic fields are only exploiting a small fraction of their associated degrees of freedom and the device performances in this regard are limited. Traditionally, bulk homogeneous materials with uniform dielectric constants are used to alter the trajectory of light at material interfaces; for example, lenses are often produced from polished glass or injection-molded plastic shaped into spherical surfaces that refract light. The performance of these refractive optical technologies is ultimately limited by aberrations, and they often cannot perform more than a single function (i.e. an individual wavefront response to an incident electromagnetic wave).

The development of gradient index (GRIN) optics, in which the refractive index is continuously varied throughout a device, has enabled far greater control of light in the ray optics limit, such that rays of light can be smoothly bent through a material volume instead of refracting at interfaces. These grayscale media based on molecular diffusion, porosity, or liquid crystals are difficult to produce and have limited refractive index contrast; for example, GRIN optical fibers typically possess less than 0.05 difference in index. See, e.g., Koike, Yasuhiro, Takaaki Ishigure, and Eisuke Nihei, High-bandwidth graded-index polymer optical fiber, Journal of Lightwave Techn., Vol. 13, No. 7 (July 1995): 1475-1489. Grayscale dielectric media has been explored in the production of spherical lenses, for example, Luneburg lens, Maxwell's fish-eye lens, and Eaton lens, where the refractive index assumes a smooth gradient. Transformation optics also rely on a gradient permittivity and permeability distribution to alter propagation direction of light rays. Aspects of the above disclosures which mention GRIN optics are directed to being in the ray optics limit, where the changes in the dielectric constant are slowly varying and are on the length scales comparable to the wavelength. As a result, rays follow curved trajectories throughout the media governed by refraction. In contrast, aspects of the present disclosure are different in that, as the length scale of grayscale dielectric function is (deep) subwavelength, the coupling between light and subwavelength material can only be captured by wave optics with full-wave electromagnetic modeling. The light-matter interaction will also generate much richer phenomena and support a lot more degree of freedoms.

Metamaterials are a relatively new class of electromagnetic device that surpass conventional optical engineering limits. Metamaterials are composed of sub-wavelength meta-units that shape electromagnetic wavefronts, and their properties are dictated by the subwavelength structuring instead of the constitutive material properties. Phenomena that are difficult or impossible to find in nature can be realized, like negative refractive indices or invisibility cloaking. See, e.g., Smith, David R., John B. Pendry, and Mike C K Wiltshire, Metamaterials and negative refractive index, Science 305.5685 (2004): 788-792. Metamaterials in the optical, THz, and microwave frequencies have been realized. In general, current electromagnetic metamaterials are limited to single or no more than a few planar layers, and are composed of solid-void structures (two material or binary dielectric constants composition).

Commercially, complex functionality like aberration correction is achieved modularly, in which many optical elements are combined; for example, a typical phone camera consists of around five to six specially shaped lenses to combat chromatic aberration. Multi-layer metasurfaces have recently shown the possibility in achieving multifunctionality because they support many spatially overlapping optical modes. See, e.g., Yang, Jianji, David Sell, and Jonathan A. Fan., Freeform metagratings based on complex light scattering dynamics for extreme, high efficiency beam steering, Annalen der Physik Vol. 530, Issue 1 (2018): 1700302. However, a much larger number of modes and grayscale refractive index with high contrast would be used or needed to provide the degrees of freedom necessary to produce high efficiency devices. See, e.g., D. A. B. Miller, Fundamental limit for optical components, J. Opt. Soc. Am. B 24, A1-A18 (2007).

Previously-known approaches are nowhere near the fundamental limits of optical engineering, and these limits present significant technical problems and challenges including as examples: attempting to implement control over electromagnetic wavefronts via conventional binary materials at length scales that are small relative to the operating wavelength; and using conventional materials providing limited access to the number of otherwise available optical modes as desirable for producing high-performing, multifunctional electromagnetic devices.

In somewhat related aspects of optical engineering, conformal multifunctional metamaterials that support wave responses as a function of incidence wavelength and angle are enabling technologies for sensing, communication, and imaging where the system's form factor plays as large a role as its electromagnetic response. For aircraft and autonomous cars, systems ideally conform to the shape of the curvilinear vehicle body, which is primarily informed by aerodynamics design. Smart homes require sensors to seamlessly blend in with the environment and have form factors dictated by ergonomics and aesthetics. Optical systems featuring advanced functionality, such as mixed-reality (e.g., meta-verse, gaming, etc.) devices or ultra-wide field of view imaging systems, require non-planar layouts to maximize performance.

There have been several proposed approaches to realize electromagnetic metamaterials that are either conformal or multi-functional. Conformal metamaterials have been fabricated and characterized with thin film metasurfaces that possess a phase response tailored for a given incidence wave condition. However, they are fundamentally limited in bandwidth and cannot generalize to support multi-functional operation because they rely on resonators that support local optical responses. Volumetric metamaterials based on transformation optics offer wide-angle responses and curvilinear form factors, but they are difficult to extend to arbitrary geometries, require hard-to-achieve material properties, and cannot support arbitrary frequency-multiplexed functions.

Further, volumetric metamaterials with subwavelength-scale material variations can be optimized by using inverse design techniques (e.g., as discussed by Molesky, S. et al. Inverse design in nanophotonics. Nature Photonics 12, 659-670 (2018), and Sell, D., Yang, J., Doshay, S., Yang, R. & Fan, J. A. Large-angle, multifunctional metagratings based on freeform multimode geometries. Nano letters 17, 3752-3757 (2017). These devices use optimization to leverage volumetric, non-local wave interactions within the metamaterial bulk, and they have been experimentally demonstrated in a variety of beam steering, mode conversion, and wavelength splitting tasks. However, existing demonstrations remain limited to binary material systems typically with low dielectric contrast, which lead to relatively thick devices and limited functional capabilities and efficiencies. Additionally, they are not conformal in part because they are typically designed with Cartesian grid-based features.

These and other matters have presented challenges to optical-engineering designs and to the efficiencies of optical and optically-related systems, for a variety of applications.

### SUMMARY OF VARIOUS ASPECTS AND EXAMPLES

Various aspects and examples according to the present disclosure are directed to issues (and elements and structures) such as those addressed above and/or others which may become apparent from the following disclosure involving optical engineering and related systems and devices and/or engineering optical systems, devices and/or structure (e.g., materials engineered to manipulate light directed towards the materials) though the use of grayscale dielectric media, computational metamaterial design, and/or volumetric fabrication.

According to the present disclosure, exemplary specific embodiments are directed to methods for producing or accessing a grayscale dielectric profile associated with a certain electromagnetic response; and via the grayscale dielectric profile, providing a three-dimensional metamaterial corresponding to the certain electromagnetic response.

In related aspects, the present disclosure is directed to optically-engineered structures involving three-dimensional (3D) or volumetric metamaterials, having a grayscale dielectric profile, to produce a certain electromagnetic response. In more specific examples, the 3D metamaterial may be implemented to approximate a grayscale continuum of dielectric constants, and may conform to curved and/or irregular shapes for use in a wide variety of applications such as electromagnetic devices which operate via communication of radiating waves that may be steered and/or manipulated as a function of frequency.

In more specific embodiments which may build on the above aspects: a grayscale dielectric profile is produced by using an algorithm, based on topology optimization and/or an inversion design, to create the grayscale dielectric profile linked with a specified or desired electromagnetic response; the three-dimensional metamaterial may be produced to correspond to the certain electromagnetic response by using an additive process to form the three-dimensional metamaterial and, further, the additive process may accumulate sets of multiple filaments, having dielectric constants within one or more selected ranges, to form the three-dimensional metamaterial.

In connection with the above and other examples, such a three-dimensional metamaterial may render at least a part of a cloaked surface so as to appear invisible, and may include sets of multiple filaments, having dielectric constants within one or more selected ranges, and the three-dimensional metamaterial may be used to provide multiple electromagnetic modes of operation.

In another specific aspect, the present disclosure is directed to using a three-dimensional printer to form the three-dimensional metamaterial in substructures or unit cells, each based at least in part in a resin material, and further including curing the resin material, and wherein the resin material includes dopant nanoparticles to set a part of the three-dimensional metamaterial to have one or more dielectric constants within one or more respective selected ranges for producing the certain electromagnetic response.

With the above and other examples, the three-dimensional metamaterial may be used to control and direct electromagnetic waves in the microwave frequency range and/or the millimeter wave frequency range, and the three-dimensional metamaterial may further be used for coupling or decoupling the electromagnetic waves in antenna arrangements including multiple co-frequency antennas.

In one or more variations of the above specific examples, the three-dimensional metamaterial may be used to control and direct electromagnetic waves in at least one of a microwave frequency range and a millimeter wave frequency range, without use of a resonator.

In certain example embodiments, aspects of the present disclosure involve at least one algorithm to produce a grayscale dielectric profile that produces a desired electromagnetic response.

In another more specific example, the present disclosure is directed to an apparatus (e.g., system, circuitry, etc.) and methodology including or involving one or more additive manufacturing processes to physically realize 3D grayscale metamaterial.

Another particular example of the present disclosure is directed to a method including or involving at least one algorithm to produce a grayscale dielectric profile that produces a specified or desired electromagnetic response, and one or more additive manufacturing processes to physically realize 3D grayscale metamaterial.

In another particular example, the present disclosure is directed to a method including or involving at least one algorithm to produce a grayscale dielectric profile that produces a specified or desired electromagnetic response, wherein the at least one algorithm is a topology-optimization algorithm.

In yet other specific examples, exemplary aspects of the present disclosure are directed to a method for manufacturing an optical system or apparatus (e.g., device, element material, etc.) which method involves the following steps or activities: using optimization and/or additive design algorithms to produce the grayscale dielectric profile that in turn is used to provide implementations for producing the specified or desired electromagnetic response, thereby physically realizing examples of the 3D grayscale metamaterials.

In yet a further specific example which may be used with the above examples and aspects, electromagnetic structures are designed by solving an inverse or adjoint variables problem, in which the device layout is iteratively optimized to improve a specified or desired output.

In yet further specific examples, aspects of the present disclosure are directed to conformal artificial electromagnetic media that feature tailorable responses, as a function of incidence wavelength and angle, to represent broadbased components for optical engineering in one or more of the above contexts. As specific examples: conformal grayscale metamaterials may be used in this regards as a class of volumetric electromagnetic media capable of supporting highly-multiplexed responses and arbitrary and/or curvilinear form factors; and subwavelength-scale voxels based on irregular shapes may be designed to accommodate a continuum of dielectric values, enabling a freeform design process to reliably converge to exceptionally high Figure of Merits for a given multi-objective design problem. Further aspects involve experimentally fabricated microwave metamaterials by using an additive manufacturing method and, based on these specific aspects, such experimental efforts have produced structures with extreme dispersion profiles, an airfoil-shaped beam steering device, and broadband, broad angle conformal carpet cloaks (e.g., to provide the appearance of being invisible). In further related aspects, conformal volumetric metasurfaces according to the present disclosure may be incorporated into devices and systems for providing compact and multi-functional imaging, sensing, and communications.

The above discussion/summary is not intended to describe each embodiment or every implementation of the present disclosure. The figures and detailed description that follow also exemplify various embodiments.

### BRIEF DESCRIPTION OF FIGURES

Various example embodiments, including experimental examples, may be more completely understood in consideration of the following detailed description in connection with the accompanying drawings, each in accordance with the present disclosure, in which:

FIG. 1 illustrates aspects, in block diagram form, of a neural network to perform population-based optimization;

FIG. 2 illustrate aspects of an example methodology for developing materials/metamaterials and related devices, involving forming, or printing, multi-material unit cells that approximate a fully grayscale design space;

FIGS. 3a, 3b and 3c illustrate further aspects involving example methods directed to unit cell discretization for achieving curvilinear configurations and/or representing curved surfaces, shapes, etc. for such materials/metamaterials and related devices as noted above in connection with the above figure(s);

FIGS. 4a-4c provide an example framework of conformal volumetric grayscale metamaterials, with FIG. 4a as a conceptual illustration of a freeform grayscale metamaterial with frequency-multiplexed functionalities, FIG. 4b as a schematic of the grayscale metamaterial fabrication process via additive manufacturing, and FIG. 4c. as a schematic of the near-field scanning setup used for metamaterial characterization;

FIGS. 5a-5d show an analysis of an example grayscale dielectric design space, with FIG. 5a as a schematic of a periodic volumetric metagrating (model system) which selectively diffracts a normally incident beam to the −1 diffraction order, FIG. 5b showing histograms of diffraction efficiency for gradient-optimized metagratings including binary and grayscale dielectric distributions, FIG. 5c showing threshold device thickness, tₜₕ, required for an optimized grayscale metagrating to achieve 99% efficiency, as a function of dielectric contrast, and FIG. 5d showing contour plot of device efficiency as a function of voxel size and number of discrete dielectric values used in the designs;

FIGS. 6a-61 show dispersion engineering in metamaterial scatterers, with FIGS. 6a, 6b and 6c respectively showing theoretical results for three types of optimized grayscale metamaterials operating across the X band, with positive linear (FIG. 6a), positive quadratic (FIG. 6b), and a combination of positive and negative linear dispersion profiles (FIG. 6c), FIG. 6d showing dielectric distribution of an exemplary grayscale metamaterial, FIG. 6e showing an image of the additively manufactured achromatic scatterer, FIG. 6f showing experimentally measured far-field scattering properties of the achromatic metamaterial, which shows a constant far-field scattering angle as a function of frequency, with FIGS. 6g-6i showing sets of experimentally measured near field distribution, where FIGS. 6g and 6h show simulated near field distribution and power flow (FIG. 6i) at f₁ with the solid lines and colormap in FIG. 6i showing the direction and magnitude of the Poynting vector, respectively, and FIGS. 6j-6l corresponding to the parameter set of FIGS. 6g-6h but at f₂ as opposed to f₁;

FIGS. 7a-7e illustrate beam forming and steering with an embedded line source in an airfoil-shaped metamaterial, with FIG. 7a showing dielectric distribution of an airfoil-shaped beam former that collimates and steers radiation from a coaxial antenna to different far-field directions as a function of frequency, FIG. 7b as an image of the additively manufactured airfoil-shaped beam former, FIGS. 7c-d respectively showing simulated and experimentally measured far-field properties of the airfoil device, and FIG. 7e showing measured electric near-field profiles at three different frequencies;

FIGS. 8a-8f illustrate an example of a conformal carpet cloak also in accordance with aspects of the present disclosure, wherein FIG. 8a is a design of an exemplary ground plane cloak, FIG. 8b is an image of the additively manufactured cloak and asymmetric curvilinear metallic scatterer with ground plane, FIGS. 8c-f show simulated near-field distributions of the bare scatterer with ground plane (FIGS. 8a-c), flat ground plane with no scatterer (FIGS. 8a-d), and scatterer with the conformal cloak (FIGS. 8a-e), and FIG. 8f shows that the experimental near-field distributions of the scatterer with the conformal cloak agree well with the simulated results in FIG. 8e;

FIGS. 9a-9b illustrate experimentally realized dielectric constants, with FIG. 9a showing measured complex dielectric constants of two ceramic-embedded filaments constituting the metamaterial, and FIG. 9b showing nine dielectric constant values achieved through the multilayer voxel architecture, calculated using effective medium theory.

FIG. 10 illustrates a visualization of 100 grayscale grating patterns produced by topology optimization, depicted in a 2D representation of the design space constructed using principal components analysis;

FIGS. 11a-11c show a comparison of two metagratings having different dielectric contrasts, with FIG. 11a showing dielectric constant distributions, FIG. 11b showing near fields distribution, and FIG. 11c showing power flow;

FIG. 12 shows a dielectric distribution of the three dispersion engineered devices shown in FIG. 6a-6c in the preceding text;

FIGS. 13a-13b show an effect of deviation of the incidence beam from a planewave, with FIG. 13a showing an experimental setup to generate Gaussian beam incident wave, and FIG. 13b shows electric fields distribution for device in FIG. 6h;

FIG. 14 shows the simulated Figure of Merit of the cloak under planewave incidence as a function of angle of incidence and frequency;

FIGS. 15a-15b shows the experimental ground cloak under more incident directions and frequencies with FIG. 15a showing the simulated and FIG. 15b showing experimentally measured electric fields distribution of cloaked object; and

FIG. 16a-16b show the carpet cloak illuminated with point excitation sources, with the electric field distribution of the cloaked object and corresponding flat ground plane response given (FIG. 16a) a single out-of-plane antenna probe source and (FIG. 16b) two out-of-plane antenna probe sources.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems (including subsystems and subassemblies) and methods of use/manufacture involving optics (e.g., optical-based devices, elements and/or systems). While the following discussion refers to certain specific approaches, or design algorithms, in connection with such apparatuses and systems, such discussion is for providing merely an exemplary context to help explain such aspects, and the present disclosure is not necessarily so limited. The examples and specific applications discussed herein (with and without reference to the figures), may be implemented in connection with one or more aspects, examples (or example embodiments) and/or implementations, whether such aspects are considered alone or in combination with one another.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same connotation and/or reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

Exemplary aspects of the present disclosure are related to designing and manufacturing dielectric electromagnetic metamaterials to control and direct electromagnetic waves in the microwave and millimeter wave frequency range, for a variety of systems, devices and/or applications, with performance beyond that of conventional optical engineering and state-of-the-art metamaterial design. In order to produce the optimal performance and multifunctionality, a combination of certain types of computational and fabrication techniques are disclosed herein.

Consistent with the aspects disclosed herein, such a manufactured device or method of such manufacture may involve aspects presented and claimed in U.S. Provisional Application Ser. No. 63/188,711 filed on May 14, 2021 (STFD.432P1), to which priority is claimed. To the extent permitted, such subject matter is incorporated by reference in its entirety generally and to the extent that further aspects and examples (such as experimental and/more-detailed embodiments) may be useful to supplement and/or clarify.

In exemplary contexts, such aspects of the present disclosure are directed the ability to control and direct such electromagnetic fields which, fundamentally, may be determined by the degrees of freedom of the electromagnetic medium. This may be described as a three-dimensional dielectric constant distribution, and in the present disclosure certain terms related thereto may be used interchangeably and they are dielectric constant, refractive index, and permittivity. The degrees of freedom in designing such dielectric distributions include the shape of the device (flat, spherical, or freeform), the range of dielectric constants (low contrast or high contrast), the number of different dielectric constants (single material, multimaterial, or grayscale), the thickness of the device (monolayer, multi-layer, or volumetric), and the spatial resolution of the dielectric constant variation (ray optics limit or wave optics limit). The immense design space poses great challenges in direct design methods based on physics intuition or brute force search. Machine learning based algorithms are used to globally search optimal design, and fabrication techniques based on additive manufacturing are used to enable the design.

In specific examples according to the present disclosure, certain embodiments are directed to a method and/or apparatus involving 3D grayscale metamaterial that provides a desired optical response. In accordance with certain aspects of the present disclosure, the fundamental limits of optical engineering are approached at the intersection of grayscale dielectric media, computational metamaterial design, and volumetric fabrication processes. Such exemplary aspects of the present disclosure are directed to generating anew class of metamaterial that exploits most, or all, possible degrees of freedom. In more specific examples, this may be realized via a 3D metamaterial that comprises a continuous grayscale range of dielectric constants with spatial variation at wavelength and sub-wavelength scales that can also conform to curved surfaces.

In more specific examples, exemplary aspects of the present disclosure are directed to a method for manufacturing an optical system or apparatus (e.g., device, element material, etc.) which method involves the following steps or activities: (1) using state-of-the-art design algorithms to produce the grayscale dielectric profile that produces the desired electromagnetic response; and (2) using one or more additive manufacturing processes to physically realize the 3D grayscale metamaterial.

According to one or more of the above and/or certain other example aspects of the present disclosure, the above-noted limits of conventional designs may be overcome by a new class of material that exploits most or in many examples all possible material degrees of freedom: a metamaterial that comprises a continuous grayscale range of dielectric constants with spatial variation at wavelength and sub-wavelength scales that can also conform to curved surfaces. Certain important issues are addressed by one or more aspects of the present disclosure and including as example: (1) Control over electromagnetic wavefronts is greatly improved by harnessing grayscale dielectric media when compared to conventional binary materials at length scales that are small relative to the operating wavelength. (2) Volumetric metamaterials can access a far greater number of optical modes, which provide more degrees of freedom to produce high performing, multifunctional electromagnetic devices. (3) Grayscale volumetric metamaterials expand the design landscape accessible to optimization algorithms and relax the constraints on neural networks by using continuous variables as opposed to binary variables. (4) Additive manufacturing techniques are used to physically realize the grayscale volumetric structures by combining multiple filament materials to approximate a fully grayscale continuum of dielectric constants. (5) Additive manufacturing techniques relax the constraints of electromagnetic design by enabling the production of curvilinear electromagnetic devices that can conform to the arbitrary physical shape of other structures.

According to certain examples, the present disclosure concerns exemplary methods for producing or accessing a grayscale dielectric profile associated with a certain electromagnetic response; and via the grayscale dielectric profile, providing a three-dimensional metamaterial corresponding to the certain electromagnetic response. In connection with but not necessarily limited to such methods, the present disclosure is directed to optically-engineered structures involve three-dimensional (3D) or volumetric metamaterials, having a grayscale dielectric profile, to produce a certain electromagnetic response. In more specific examples, the 3D metamaterial may be implemented to approximate a grayscale continuum of dielectric constants, and may conform to curved and/or irregular shapes for use in a wide variety of applications such as electromagnetic devices which operate at least in part by the communication (transmission and/or reception) of radiating waves being steered and/or manipulated as a function of frequency.

In more specific embodiments which may build on the above aspects: a grayscale dielectric profile is produced by using an algorithm, based on topology optimization and/or an inversion design, to create the grayscale dielectric profile linked with a specified or desired electromagnetic response; the three-dimensional metamaterial may be produced to correspond to the certain electromagnetic response by using an additive process to form the three-dimensional metamaterial and, further, the additive process may accumulate sets of multiple filaments, having dielectric constants within one or more selected ranges, to form the three-dimensional metamaterial.

Consistent with the above aspects of the present disclosure, such devices and/or methods may be used for producing volumetric metamaterial that features conformal form factors, highly multiplexed electromagnetic responses, and exceptionally high efficiencies. In this regard, devices may be topology optimized using the adjoint variables method (e.g., as discussed at Fan, J. A., Sell, D. & Yang, J. Device components formed of geometric structures. U.S. Ser. No. 10/725,290B2 patent (2016), and Phan, T. et al. High-efficiency, large-area, topology-optimized metasurfaces. Light: Science & Applications 8, 48, doi:10.1038/s41377-019-0159-5 (2019). The adjoint variables method is an iterative gradient-based algorithm that enables unique outgoing wave responses as a function of the wavelength and angle of incident waves. Broadband and broad angle functionality can be realized in wavelength-scale-thick devices, and via experimentally efforts, a suite of two-dimensional microwave devices are fabricated using additive manufacturing, which feature extreme dispersion engineering, conformal carpet cloaking, and/or frequency-multiplexed beam steering capabilities.

In connection with the above and other examples, such a three-dimensional metamaterial may render at least a part of a cloaked surface so as to appear invisible, and may include sets of multiple filaments, having dielectric constants within one or more selected ranges, and the three-dimensional metamaterial may be used to provide multiple electromagnetic modes of operation.

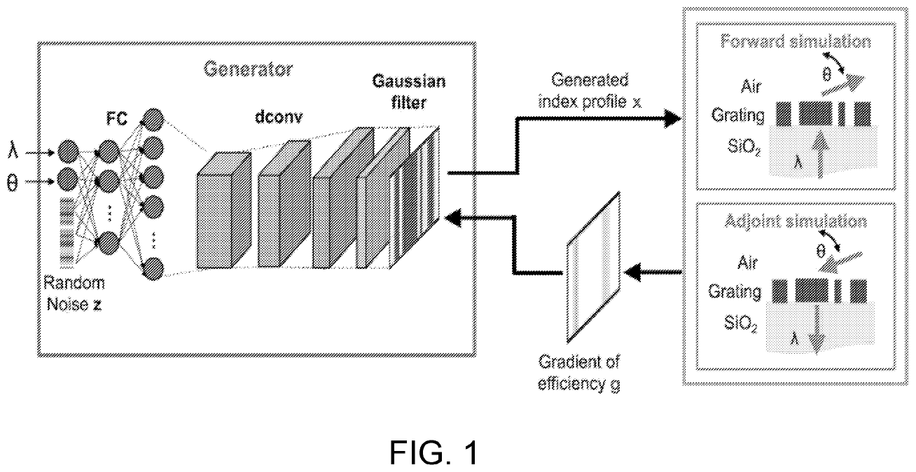

Topology Optimization. As part of certain specific experimental examples according to the present disclosure, an exemplary design algorithm, involving topology optimization, may be used. Topology optimization has been widely studied in the scientific and engineering research community to design high efficiency and multifunctional devices. In this method, electromagnetic structures are designed by solving an inverse or adjoint variables problem, in which the device layout is iteratively optimized to improve a desired output. The current state-of-the-art topology optimization algorithms are based on deep learning concepts. A physics-informed global topology optimization network (GLOnet) that is based on gradient-descent methods is used to explore the immense design space of grayscale volumetric media (see, e.g., Jiang, Jiaqi, and Jonathan A. Fan.; Global optimization of dielectric metasurfaces using a physics-driven neural network; Nano letters 19.8 (2019): 5366-5372. As illustrated in FIG. 1, GLOnets may utilize a generative neural network to perform population-based optimization. The network does not use any training set: during a training iteration, devices are generated from the network and evaluated using electromagnetic solvers, and these simulation results are combined with a specific loss function to improve the performance of devices generated by the network. Upon the completion of training and as shown in the two-dimensional (or 2D) representation of device patterns and representative efficiency histograms, these physics-informed neural networks generate a narrow distribution of devices centered around the global optimum. Benchmark results of grayscale metagratings compared to binary metagratings indicate that GLOnets can effectively search for the global optimum and outperform current state-of-the-art inverse optimizers.

Designing optical devices using grayscale dielectric media presents clear computational benefits. First, the neural network directly generates grayscale patterns so the optimization process is inherently better suited for continuous variables than binary variables. Second, the optimizable design space is larger. Third, the search landscape possesses fewer local minima in grayscale domain, as compared to the binary domain.

Exemplary processes for manufacturing. As part of certain specific experimental examples, exemplary processes for manufacturing such 3D grayscale metamaterial may use one or more additive manufacturing approaches to physically realize the 3D grayscale metamaterial. A continuous grayscale dielectric profile can be translated into a 3D printed device through stereolithography (SLA) or digital light processing (DLP) 3D printing methods. Both processes work by curing resin using a light source (a laser for SLA, a projector for DLP). Grayscale media is printed by controlling the light intensity distribution that results in varying cross-linking densities in the cured resins, which changes the material properties. The clear advantage of the SLA and DLP methods is the ability to produce highly accurate parts with smooth surfaces. High resolution is critical when scaling down to the millimeter-Wave (mmWave) and THz frequencies, and surface roughness will introduce detrimental scattering. The typical XY resolution is on the order of ˜30 μm for single photon polymerization, and submicron with multi-photon polymerization. SLA and DLP methods are ultimately limited by the dielectric constant of the resin, as the dielectric constant can only be varied from that of air (about which has a dielectric constant (ε) of about 1) to that of the resin (often with E less than 3). According to exemplary aspects of the present disclosure, the dielectric constant of the resin may be boosted by doping it with ceramic nanoparticles, while maintaining the necessary viscosity of the resin fluid used or needed by the printing process. The dielectric constants of certain ceramic materials can be up to 100 (i.e., ε=100) in the few GHz frequency range, and a loading of volume fraction of 10% can therefore produce a considerably high index resin. To this end, fused deposition modeling (FDM) offers complementary capabilities for fabricating multifunctional volumetric metamaterials because filaments with high dielectric constants (e.g., upwards of 15 or ε≥15) are commercially available. Commercially available thermoplastics like acrylonitrile butadiene styrene (ABS) are doped with varying amounts of ceramic nanoparticles to increase the dielectric constant of the extruded material; as an example, see www.preperm.com/products/stock-shapes/#filaments.

One example strategy for converting a grayscale dielectric profile into a 3D printer compatible physical layout may be implemented by subdividing the design area into an ensemble grid of unit cells and specifying the dielectric properties of each unit cell through the aforementioned optimization process. Each unit cell is printed with subwavelength-scale dimensions. As the minimum resolution achieved by FDM printing is on the micrometer to millimeter scale, the operating free space wavelengths must be centimeter-scale.

There are numerous strategies for converting a grayscale dielectric profile into 3D printed layouts. A simple method involves printing unit cells with varying sized air holes, in which the volume ratio of printed material to air can capture an effective dielectric constant whose value lies between the printed material and air. Similarly, by varying the density of ceramic composition in a solid medium (for example, by controlling light exposure using SLA or DLP printing), a grayscale material profile can be created. However, a nascent method for producing the widest continuum of dielectric constants that is compatible with FDM approaches relies on the effective medium method. Through this effective medium approach, the dielectric constant of each unit cell is specified by varying the volume-filling-ratio of different filament materials within each unit cell to capture the desired local grayscale dielectric value. Importantly, the size of the unit cells is very small relative to the wavelength.

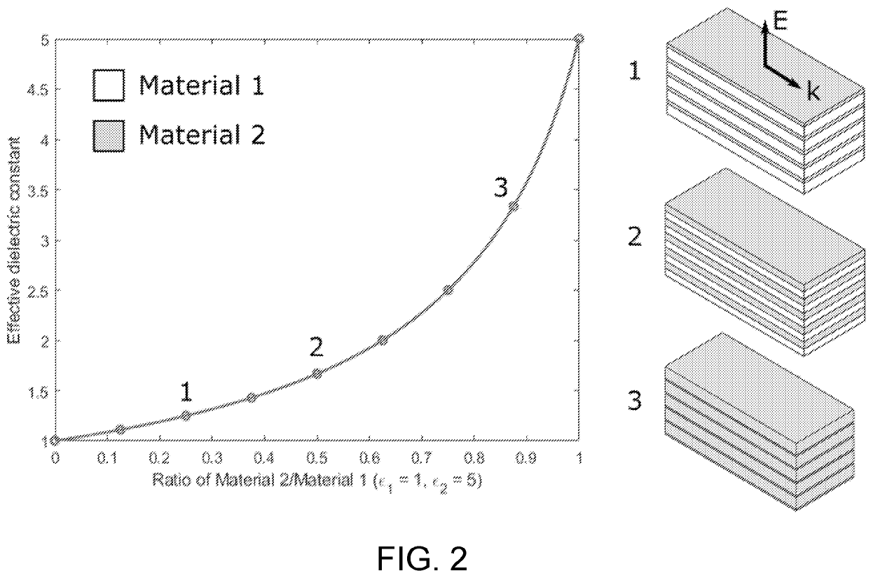

For an electric field that is polarized in the vertical direction, a grayscale continuum of dielectric constants between two discrete values can be approximated by alternating horizontal layers of discrete materials. In FIG. 2, such layers are shown as layered sets 1, 2 and 3 (each with multiple layers). FIG. 2 further shows the layers including a first material (Material 1) and a second material (Material 2), with a graph showing for each set of layers the effective dielectric constant along the Y axis and the ratio of Material 2/Material 1 along the X axis. As long as the periodicity of the layers is much smaller than the operating wavelength, the fields experience an effective dielectric constant whose value lies between the dielectric constants of the two discrete materials. Using an FDM printer with the capability of printing from many discrete dielectric filaments, multi-material unit cells can be printed that approximate a fully grayscale design space (as depicted in FIG. 2). Thus, by alternating layers of different filaments, metamaterials can progress from binary (two materials) to discrete (e.g., multi-material with few discrete levels of dielectric constant) to continuous (corresponding to an approximated grayscale continuum of dielectric constants). The resultant object is a monolithic solid with continuously varying optical properties, which ensures mechanical stability and printing feasibility.

In addition to isotropic media, it is also possible to generate anisotropic media using additive manufacturing, that is, the permittivity of an individual voxel appears different for different incident light polarizations. The most intuitive anisotropic voxel is an asymmetric 3D cross, where the width of the bars along three axes are varied. Because of the different volume filling ratio along three Cartesian axes, a diagonal permittivity tensor can be realized. More complex anisotropic voxels can be created through a topology optimization approach, in which the dielectric constant distribution in each unit cell is optimized to obtain used or needed phase shift in each polarization. In the case of cylindrical and spherical coordinate systems (which are useful for cloaking applications), anisotropic voxels can be created in similar inverse design manners.

Another advantage that 3D printing in connection with the present disclosure offers is that it allows devices to be configured and integrated into useful shapes and form factors that are not compatible with planar silicon-based metamaterial design. Therefore, these systems are compatible with conformal optics, in which the shape of optical elements follow the arbitrary contours of a mechanical structure, which was originally proposed for aerial vehicles whose shapes are specifically tailored for aerodynamics. According to the present disclosure, 3D printed metamaterials can be made to conform to a broad range of objects, like door handles, eyeglass frames, and airplane wings, which is functional with electromagnetic structures conforming to unusual curvilinear shapes. Additionally, 3D printing offers a low-cost implementation to validate theoretical designs via high speed printing processes that are not achievable with conventional metamaterial fabrication procedures in semiconductor foundries.

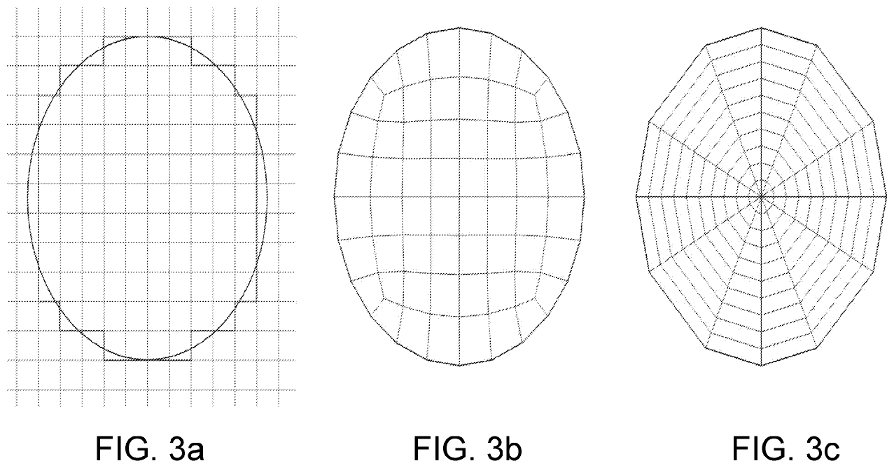

In order to achieve these curvilinear configurations, a strategy for unit cell discretization is may be used as disclosed herein according to the present disclosure. In this context, the most common unit cell type is cubic, in which a volume is straightforwardly discretized into equally sized sub-wavelength cubic voxels each with its own specified dielectric constant. Forms of such structures are shown in FIGS. 3a, 3b and 3c. However, this rectangular grid can prove to have limited efficacy for 3D printed freeform grayscale metamaterials. Geometric mismatches between the cubic lattice structure and contoured layouts yield stair-casing problems, in which a curved surface is poorly approximated by a staircase-like series of straight, rectangular boundaries, which can lead to inaccurate effective medium responses. Aspects and embodiments consistent with the present disclosure introduce and disclose a unit cell discretization scheme, in which unit cells take the form of triangular and quadrilateral shapes without fixed dimension. This discretization scheme is analogous to the use of tetrahedral and quadrilateral meshes in the finite element method (FEM), which better represent curved objects (FIGS. 3b-3c) than cubic voxels as with FIG. 3a. Thus, stair-casing artifacts are eliminated, and the desired dielectric distribution is more accurately captured. The unit cells can be made relatively large to take the minimum resolution of the 3D printer into consideration.

More-specific examples. Certain aspects of the present disclosure may be used in related and/or more-specific example embodiments and exemplary applications. For instance, the present disclosure describes and/or illustrates aspects useful for implementing the claimed disclosure by way of terms such as different kinds of materials, metamaterials, devices, systems, units, elements, and/or other optical-related or optical-type depictions. Such structures may be used together with other elements to exemplify how certain embodiments may be carried out in the form or structures, steps, functions, operations, activities, etc.

Within industry, 3D printing strategies of the present disclosure can offer a low-cost procedure to rapidly prototype and implement simulated optical designs either before or as an alternative to fabrication in semiconductor foundries. The ability to produce fully 3D, volumetric metamaterials enables high efficiency multifunctional devices that produce distinct responses for different incident waves. For example, multifunctionality where the electromagnetic response is dependent on incident wavelength will enable next generation wavelength-multiplexed lensing, beam steering, and image filtering applications. The strategies disclosed herein can enable modalities wireless communication, integrated circuits, and sensing, according to the present disclosure. A few such examples are discussed below.

One example concerns automotive and aerial radar sensor. In this context and according to the present disclosure, a grayscale dielectric device is co-designed with an antenna array to achieve beam-forming for radar imaging and ranging applications on automotive and aerial systems. More specifically, dielectric metamaterial is designed into a form factor that conforms to the car bumper (or other equivalent/projecting automotive structure), and couples to a patch antenna array mounted behind the metamaterial. The dielectric metamaterial functions as a multifunctional lens, simultaneously projecting antenna radiation from each element in the array into a different angle, such that collectively the radar sensor covers a wide field of view. By utilizing grayscale dielectric constants with high contrast, the thickness of the lens may be significantly reduced to a fraction of a conventional mmWave refractive lens, and at the same time maintaining good impedance matching to free space. In addition, the plastic protection enclosure (radome) that covers the radar sensor may be co-designed (according to the present disclosure) to improve the transmission of the millimeter (mm) waves. Compared to current automotive radar technology, certain example embodiments of the present disclosure do not require complex active beam-forming techniques, and offers a cost-efficient way for wide detection angle and compact form factor.

Another example concerns millimeter-Wave (mmWave) and terahertz (THz) interconnects between chips. As aggregated data rate often requires over-wired interconnections are approaching terabit/second (Tbps) levels, current physical channels are nearing their limits, both in terms of power consumption as well as bandwidth and capacity constraints. To this end, high capacity, low-cost planar and 3D interconnect technology based on mmWave dielectric/plastic waveguides is an alternative to current metallic interconnects. In such example embodiments according to the present disclosure, grayscale waveguides are designed to support multiple modes and their dispersion is engineered to support a broad bandwidth. In particular, the coupling between the antenna and the waveguide may be optimized using 3D freeform microlens via the above exemplary steps and/or aspects.

Another example concerns mmWave filters and frequency-division multiplexer. High-bandwidth communications often require the ability to multiplex and demultiplex (mux/demux) signal channels carrying independent data streams. The challenges of wireless communication in the mmWave range place new demands on the technologies of the physical layer. In this context, aspects and example embodiments of the present disclosure are applied to create efficient filters based on complex dielectric resonance modes. Grayscale dielectric multiplexers are also realized to spatially separate different frequencies.

Another example concerns broadband dielectric reflect-array antennas. High-gain reflectarrays are widely used in many applications of mmWave systems including remote sensing, stand-off imaging, and radar. The majority of reflectarrays are designed using the microstrip reflecting elements with variable geometric parameters on a planar substrate. These designs are based on resonance phenomenon and thus inherently suffer from narrow bandwidth. Using certain embodiments of the present disclosure, broadband dielectric reflect-array antennas are realized, where the dielectric constants and height of each element can be strategically optimized using the physics-informed neural networks.

Yet another example concerns compact integration of 5G MIMO mobile phone antennas. Massive multiple-input and multiple-output (MIMO) is an essential technique of fifth-generation (5G) communication systems. The channel capacity for 5G can be enhanced once a large number of antennas are available at base stations and mobile terminals. Generally, about 4-8 MIMO antennas operating at sub-6 GHz spectrum are sought in 5G mobile phones. However, the area and ground clearance reserved for antenna designs in up-to-date smartphones are extremely squeezed. Aspects and embodiments of the present disclosure may be used to provide the basis for advanced decoupling techniques and integrated MIMO antenna schemes to minimize the space allocation of multiple co-frequency antennas for accommodating the ongoing 5G evolution, with the mutual coupling between closely spaced antennas using a thin film dielectric grayscale metamaterial on top of the MIMO antennas being mitigated. The thin film may be used to shape the wavefronts of the different antennas, such that their mutual coupling are minimized through spatial and polarization control.

Among other examples, another representative example concerns hyperspectral imaging. Aspects and embodiments of the present disclosure may be used to provide the ability for structured grayscale devices to correct for aberration and shape electromagnetic wavefronts as a function of polarization, incident angle, and wavelength to enable new classes of hyperspectral imaging, multispectral sensing, beam steering, ranging, communications, and integrated optical computing platforms.

In connection with successful experimental efforts of proof of concept examples, the platform achieves impressive and/or surprising properties by leveraging metamaterial voxels that possess dielectric constant values spanning a high contrast grayscale continuum. The grayscale dielectric landscape advantageously offers an expanded design space which supports many exceptionally high performing device designs, many of which are accessible using local gradient-based optimization. It is also a natural design landscape for the adjoint-variables method, which uses dielectric constants in each voxel to be initially relaxed to grayscale values, followed by gradient calculations that are used to perturb these values. A wide range of dielectric values are used in these experiments to ensure that the metamaterial can support strong multiple scattering, which provides the necessary light-matter interactions for high efficiency wavefront engineering in relatively thin devices. In certain examples, this approach of the present disclosure is unlike previous approaches where dielectric constant values are explicitly constrained to two discrete values such as by using level set formalisms or regularization terms in the objective function.

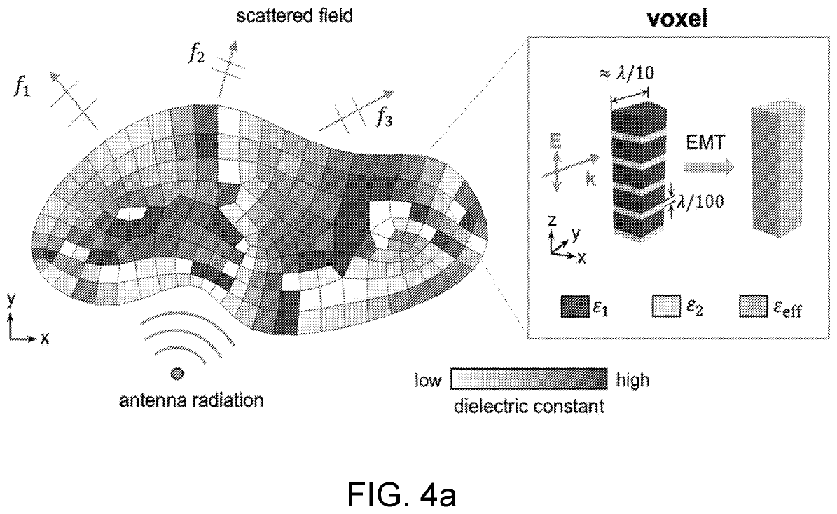

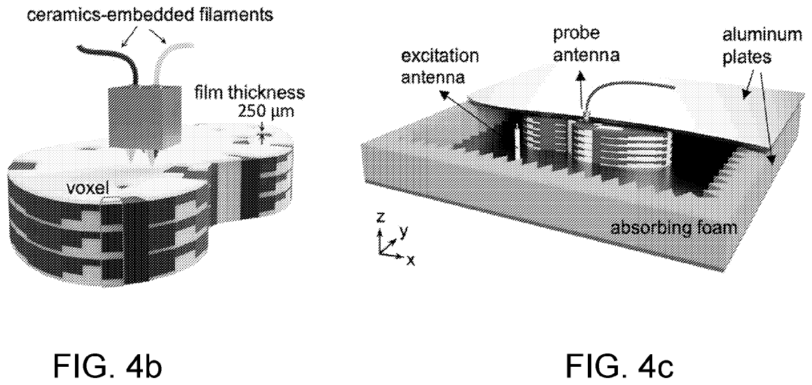

To practically achieve grayscale dielectric values in this metamaterial, a hierarchical material architecture approach is used as outlined in FIGS. 4a-4c. FIG. 4a conceptually illustrates a freeform grayscale metamaterial with frequency-multiplexed functionalities, wherein the volumetric metamaterial may be composed of irregularly shaped subwavelength-scale voxels with effective grayscale dielectric constant values that are specified using gradient-based optimization. The inset in FIG. 4a shows each voxel having an ultra-subwavelength-scale dielectric composite that yields grayscale dielectric values in the effective medium theory (EMT) limit.

First, the freeform device (or freeform grayscale metamaterial) is discretized into triangular or quadrilateral voxels with a critical dimension of approximately λ/10. A freeform discretization based on finite element method meshing ensures that the discretized device captures a high-quality reconstruction of the desired shape curvature. Second, the voxels are further discretized into a series of horizontal thin films, each with a thickness of approximately λ/100 and each possessing dielectric constant values of either ε₁ or ε₂. At this extreme subwavelength length scale, the dielectric response of each voxel for transverse electric (TE) polarized fields (i.e., fields perpendicular to the film stack) can be described with the effective medium theory (EMT):²¹ε_{eff}⁻¹=fε₁⁻¹+(1−f)ε₂⁻¹, where f is the fill fraction of ε₁.

Exemplary devices designed for operation in the X band (8-12 GHz) are fabricated using additive manufacturing methods based on fused filament fabrication (FIG. 4b). The manufacturing apparatus can print two types of ceramic-doped acrylonitrile butadiene styrene (ABS) filaments with high and low dielectric constant values, respectively. Detailed characterization (see Supplementary Information S1) indicates that the dielectric constant values of bulk materials printed from the two filament types are ε₁=2.67 and ε₂=8.40, respectively. The spatial resolution of the extruded filaments is 250 μm, which ensures that the multilayer voxels within the metamaterial have responses well into the effective medium limit at frequencies of interest. To evaluate device performance, the electromagnetic fields may be mapped using a near-field scanning apparatus comprising a parallel plate waveguide that supports the fundamental TE mode in the X band (FIG. 4c). Electromagnetic wave excitations are introduced into the waveguide using either a coaxial antenna or a coaxial-to-waveguide adapter (see Supplementary Information S3). The complex electric field distribution is measured by mechanically scanning a probe antenna attached to the top substrate (e.g., aluminum plate).

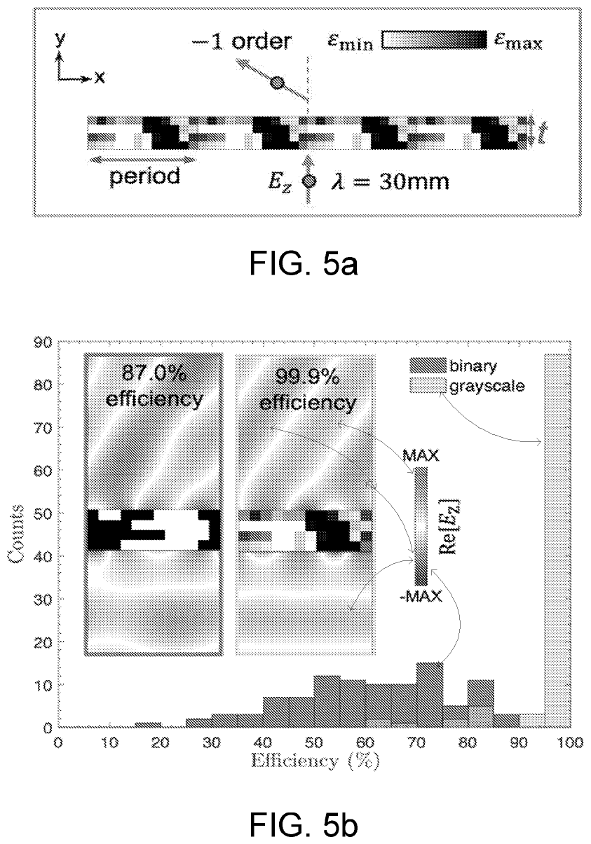

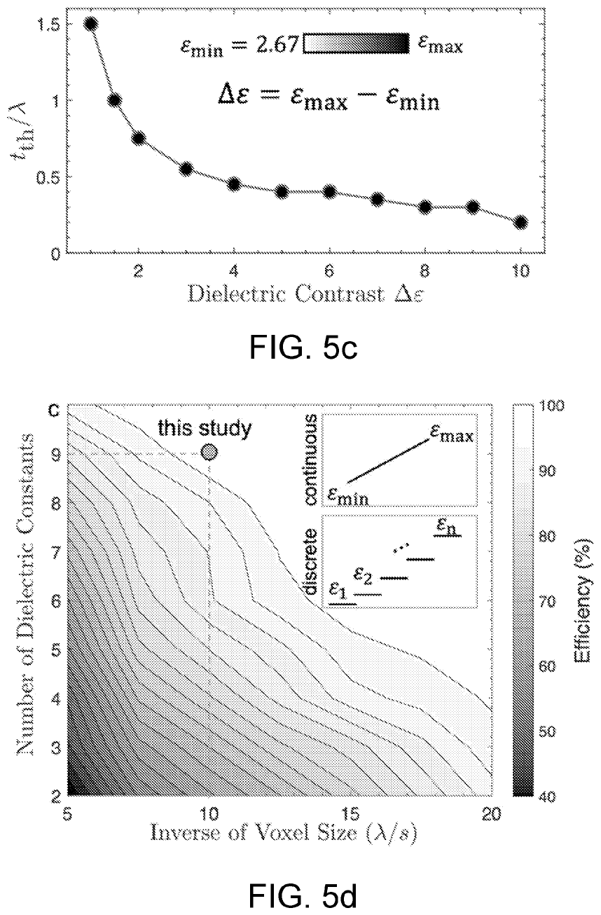

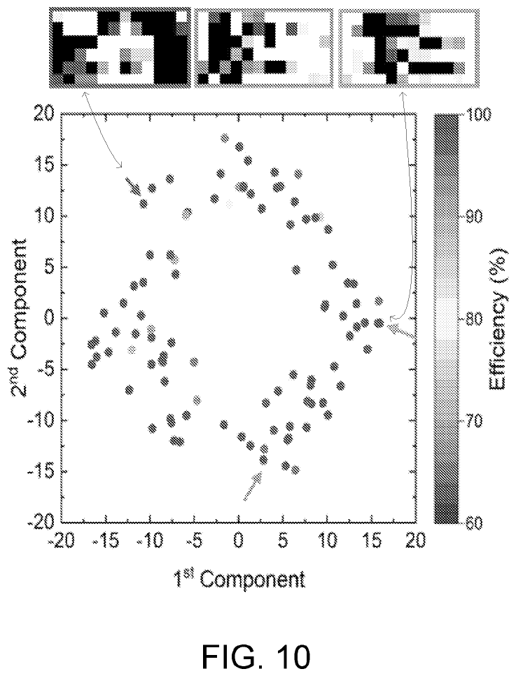

To quantify the advantages of the grayscale dielectric landscape for electromagnetic device design, volumetric metagratings are used as a model system. The optimization objective is to maximize the power diffracted into the −1 order for normally incident TE polarized waves with λ=30 mm (FIG. 5a). Efficiency histograms of two types of devices designed using gradient-based optimization, one comprising a continuous grayscale dielectric distribution and the other a binary dielectric distribution, is summarized in FIG. 5b. In this example context, for each device type, one hundred devices are designed with random initial dielectric distributions. FIG. 5b shows that the efficiency histograms for binary devices span a wide range of values, indicating that the optimization landscape comprises many local optima with widely varying efficiencies. The histograms are of diffraction efficiency for gradient-optimized metagratings including binary and grayscale dielectric distributions, and for both device types, the device thickness is 0.4λ and optimization is performed on 100 randomly initialized dielectric distributions. The insets show single unit cell device layouts, electric field responses, and diffraction efficiencies of the best binary (blue or darker box) and grayscale (yellow or lighter box) devices from the histograms. The best binary device has an efficiency of 87.0% and the associated near-field distribution shows aberrated outgoing wavefronts as in the inset of FIG. 5b. On the other hand, the distribution of grayscale device efficiencies is strongly peaked near 99.9%, indicating that local gradient-based design algorithms are effective and computationally efficient for these devices. Interestingly, these high performing devices all have widely varying layouts (FIG. 10), indicating that while the optimization landscape is non-convex, there exist many local optima featuring exceptional performance. A field plot of the outgoing wave for the best grayscale device shows an ideal planewave profile with no discernable aberration (FIG. 5b inset).

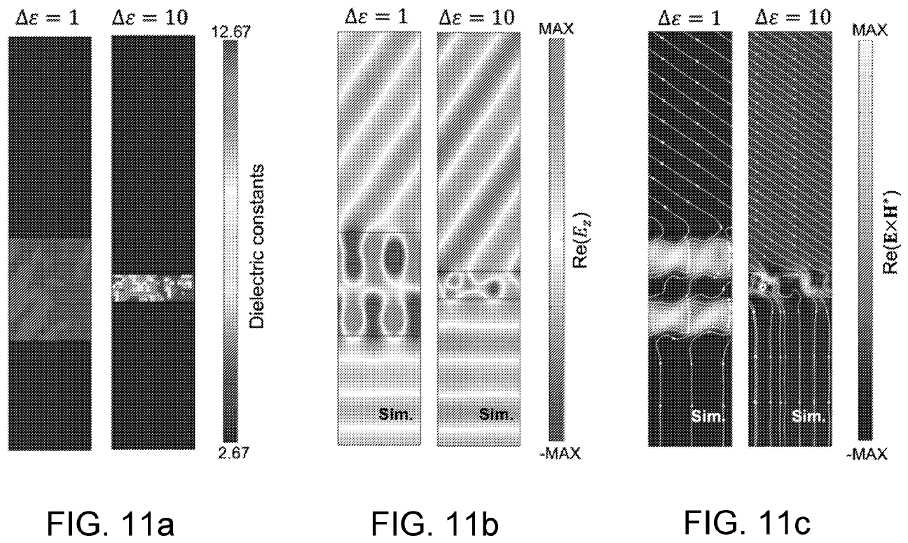

High dielectric contrast plays a significant role in dramatically reducing the thickness of high performing metamaterials, which is particularly important in microwave devices where wavelengths are centimeter-scale. To quantify this, fully grayscale metagratings are optimized with a range of thicknesses and dielectric contrast values, which may be defined as Δε=εₘₐₓ−εₘᵢₙ with εₘᵢₙ=2.67. The voxel dimensions are fixed to λ/20. The threshold device thicknesses required to realize device designs with 99% device efficiencies as a function of ΔE are plotted in FIG. 5c. When Δε is low, the device thicknesses are required to be on the order of or greater than the wavelength. While these devices utilize non-local interactions to tailor the phase response, light-matter interactions are limited to scattering and waveguiding phenomena in the forward direction (FIGS. 11a-11c). As Δε increases, the minimum device thickness drops over 7× to values much less than the wavelength. These thickness reductions are due not only to enhanced field compression and confinement in high dielectric constant regions, but also to strong multiple scattering effects that enable higher quality factor modes and particularly strong non-local waveguiding effects (FIG. 11a-11c). In this regime, the metamaterial operates with efficiencies and multi-functional capabilities far beyond the limits of metasurfaces that rely on local field interactions.

FIG. 5d shows a contour plot of device efficiency as a function of voxel size and number of discrete dielectric values used in the experimental designs, with the label ‘c’ in the y axis of FIG. 5d standing for continuous grayscale distribution. The device parameters used for further metamaterial design in these experimental efforts are denoted. The inset of the illustration of FIG. 5d includes continuous and discrete dielectric constant values.

More specifically, a parametric analysis of metagratings as a function of voxel size and dielectric discretization, shown in FIG. 5d, indicates that devices comprising multiple discrete dielectric values have efficiencies that effectively converge to those of grayscale designs. This functional equivalence between multi-material and grayscale metamaterials is important because in practice, the voxel films fabricated from the additive manufacturing process have finite thickness that prevents continuous tuning of ε_{eff}. In the limit where the smallest simulated voxel size is λ/20, device efficiency converges to that of continuously grayscale devices, even when the number of discrete dielectric values is small. Here, ensembles of voxels in the x-y device plane have electromagnetic properties that can be effectively homogenized in the grayscale limit. As voxel size increases, metagratings possessing discrete dielectric values can only operate as efficiently as those with grayscale values with sufficiently large number of materials. These experimental efforts consider devices comprising voxels with λ/10 and nine possible dielectric values between ε₁=2.67 and ε₂=8.40, and they exhibit the same efficiencies as their grayscale counterparts. As these devices are optimized primarily in the continuous grayscale landscape and dielectric discretization negligibly changes the device layout or performance, one may consider them to be effectively operating in the grayscale limit.

In a first set of device demonstrations, it is shown that volumetric metamaterials can be configured to support beam deflection behavior with nearly arbitrary dispersion responses. Materials featuring customizable dispersion are critical for many electromagnetic systems, where they are used to compensate for chromatic aberrations, can enhance spectral resolution for spectroscopic applications, and can directly provide achromatic wavefront shaping capabilities.

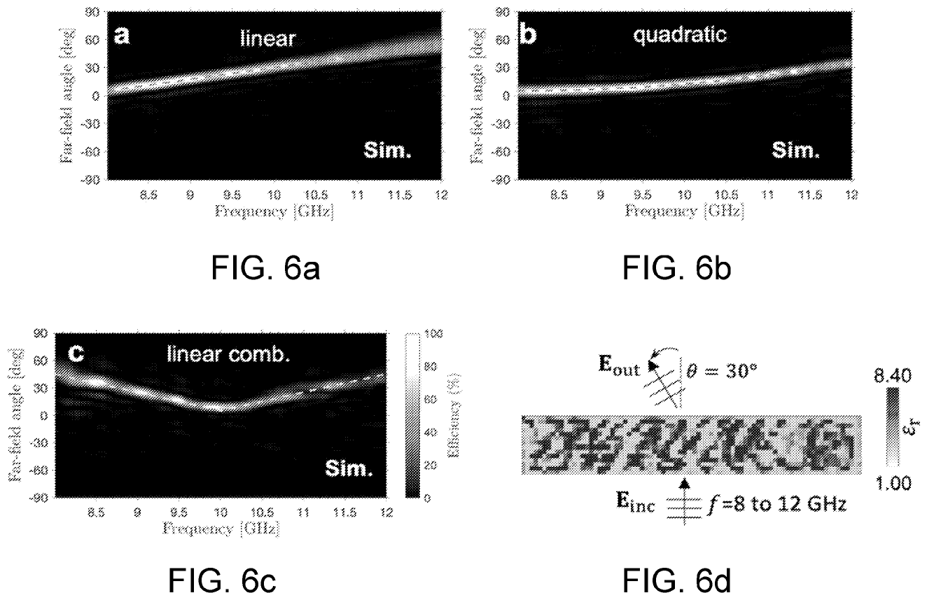

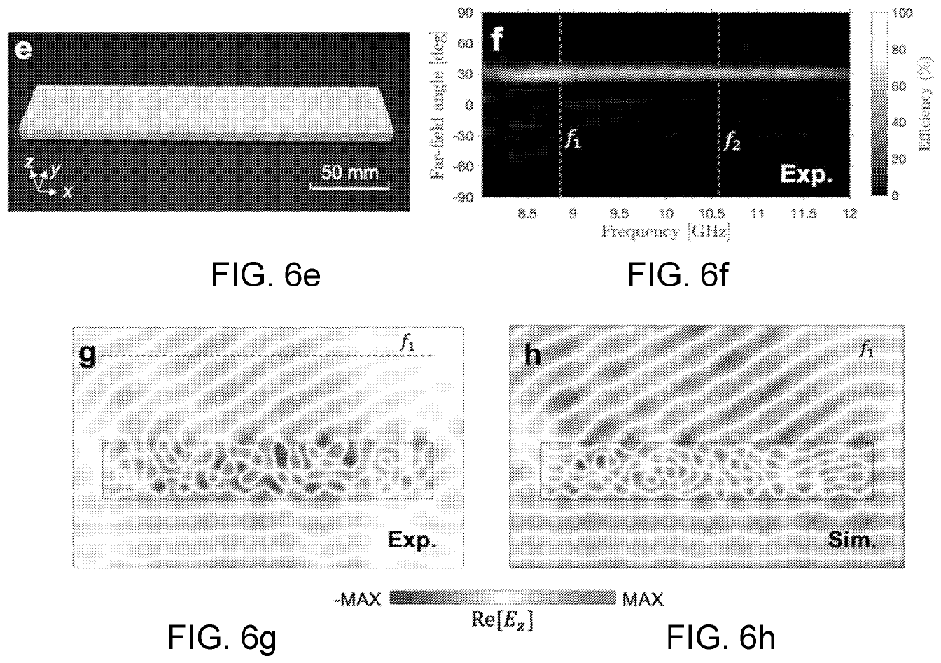

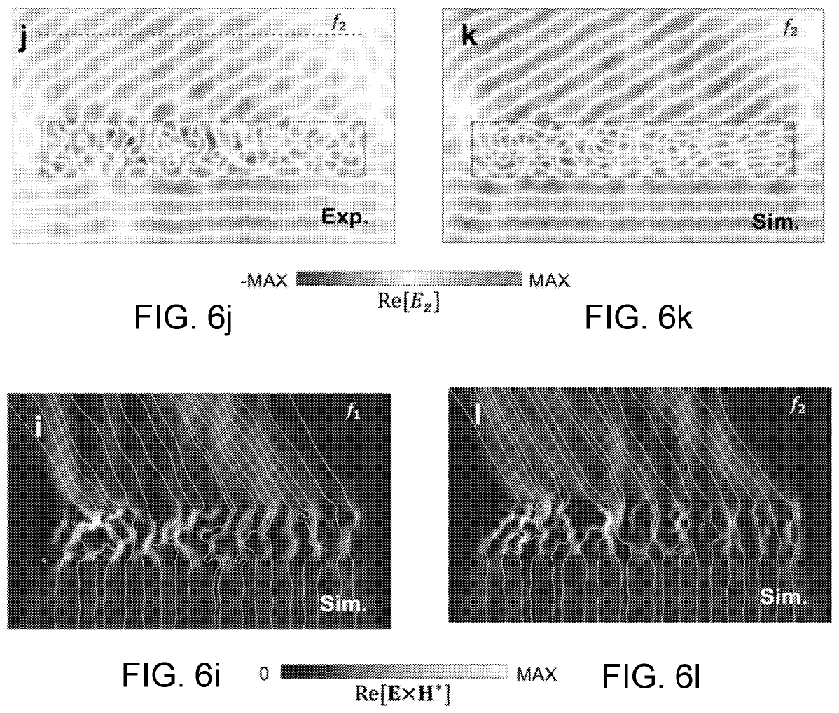

FIGS. 6a-61 show dispersion engineering in metamaterial scatterers, with FIGS. 6a, 6b and 6c respectively showing theoretical results for three types of optimized grayscale metamaterials (i.e., simulated far-field properties of three inverse designed grayscale metamaterials) operating across the X band, with positive linear (FIG. 6a), positive quadratic (FIG. 6b), and a combination of positive and negative linear dispersion profiles (FIG. 6c). These devices are designed to exhibit unusual dispersion profiles spanning the X band and they include a linear positive profile, quadratic positive profile, and a hybrid profile that is linear negative followed by linear positive. Such profiles exceed the capabilities of traditional metasurface dispersion engineering approaches, which are limited by the local optical responses of subwavelength-scale waveguide and resonator elements. The congruency between the target scattering angles and device scattering profiles, and their strong directional scattering characteristics, indicate the potential of grayscale volumetric metamaterials to perform extreme dispersion tasks.

To demonstrate that these concepts can be readily implemented in a physical device, these efforts experimentally fabricate and characterize an achromatic device that deflects normal incident fields to θ=300 for all X band frequencies. The device has dimensions of 240 mm×42 mm×10 mm and the voxels are squares with edge dimensions of 3 mm. The grayscale dielectric distribution of the device is shown in FIG. 6d.

FIG. 6e shows an image of the additively manufactured achromatic scatterer (as printed with the device dimension being 240 mm×42 mm×10 mm), and FIG. 6f shows experimentally measured far-field scattering properties of the achromatic metamaterial, which shows a constant far-field scattering angle as a function of frequency (the dashed lines denote f₁=8.85 GHz and f₂=10.58 GHz.). The experimentally measured scattering profiles (FIG. 6f), which are obtained using a near-to-far field transformation at the device exit plane, clearly demonstrate efficient achromatic scattering across the full X band.

FIGS. 6g-6i show sets of experimentally measured near field distribution, with simulated near field distribution shown at FIG. 6g and power flow at FIG. 6i at f₁ and with the solid lines and colormap in FIG. 6i showing the direction and magnitude of the Poynting vector, respectively. The measured electric field maps at two representative frequencies, f₁=8.85 GHz (FIG. 6g) and f₂=10.58 GHz.

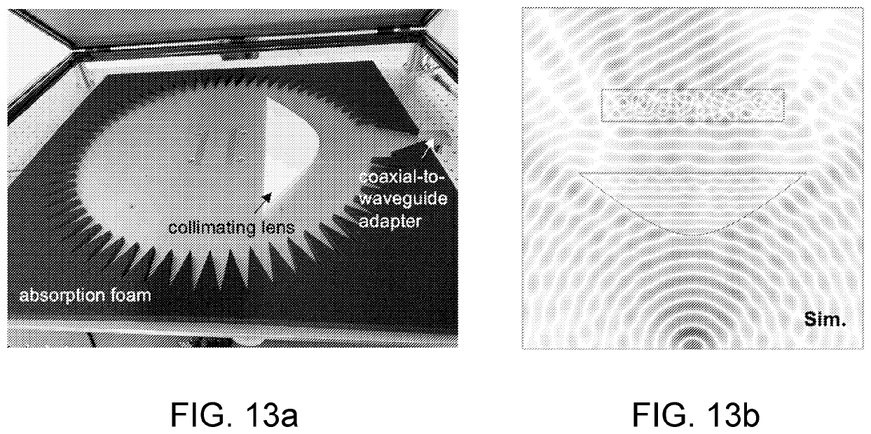

FIGS. 6j-6l corresponding to the parameters of FIGS. 6g-6i but at f₂ as opposed to f₁. The dashed lines in FIGS. 6g and 6j denote the exit plane position used for the near-to-far field transformation calculations in the far-field scattering plots. FIG. 6j displays complex mode dynamics within the volumetric metasurface that enable efficient conversion of the normally incident wavefronts into deflected wavefronts. These experimental results are consistent with simulated field maps as in FIG. 6h and FIG. 6k, which assume an incident planewave and show clear directional scattering of the output fields to the desired deflection angle. Discrepancies between the simulated and measured fields within the device region are due to deviations of the experimental incident wave from an ideal plane wave (FIGS. 13a-13b). The strong non-local light-matter interactions that enable achromatic scattering are visualized in theoretical plots of power flux in FIG. 6j and FIG. 6l, which show waves propagating in meandering pathways throughout the metamaterial volume. These light-matter interactions are qualitatively different from power flow in conventional local metamaterials, and they reveal how large amounts of phase can accumulate to enable broadband functionality within this relatively thin metamaterial.

Frequency-multiplexed wavefront engineering can be readily extended to devices with arbitrary curvilinear layouts, thereby enabling new classes of systems that simultaneously support electromagnetic and non-electromagnetic properties. As a proof-of-concept demonstration, these efforts involve the design and implementation of a volumetric beam forming metamaterial that is shaped as a miniaturized airfoil. The device shape, which is optimized for aerodynamics as may be adopted from publically available resources (e.g., UIUC Airfoil Coordinate Database at m-selig.ae.illinois.edu/ads/coord_database.html) and occupies a footprint of 240 mm×70 mm. Beam forming is achieved using an embedded radiation antenna as the source and designing the metamaterial to collimate and steer the emitted radiation to different directions as a linear function of the signal frequency. A perfect electric conductor (PEC) boundary at the bottom surface of the device prevents radiation leakage in this direction.

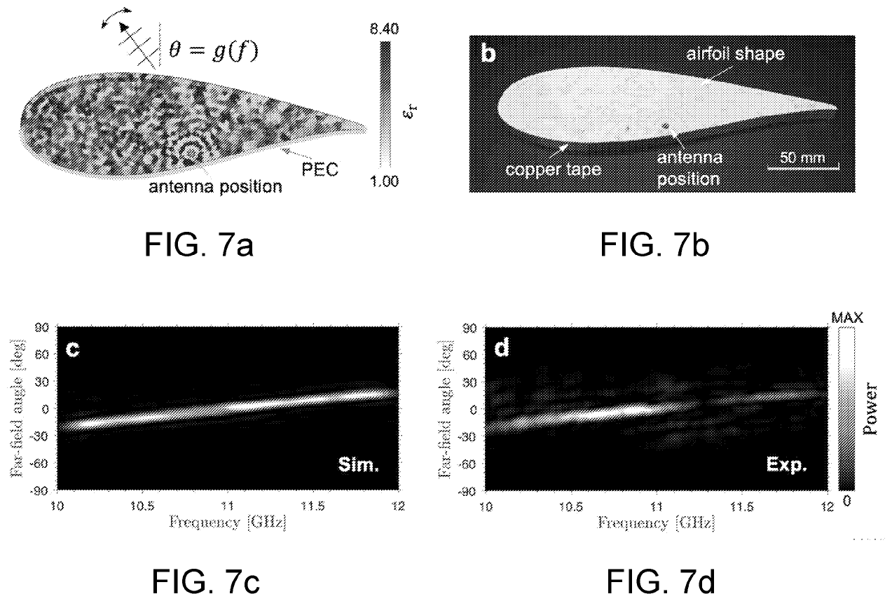

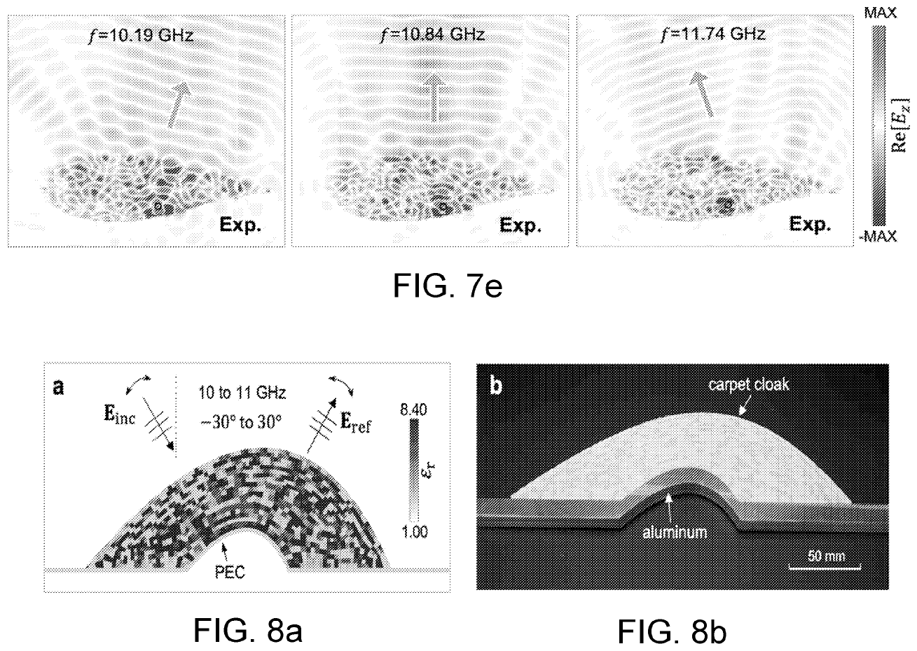

Experimental efforts are in support. FIGS. 7a-7e illustrate beam forming and steering with an embedded line source in an airfoil-shaped metamaterial, with FIG. 7a showing dielectric distribution of an airfoil-shaped beam former that collimates and steers radiation from a coaxial antenna to different far-field directions as a function of frequency. FIG. 7b is an image of the additively manufactured airfoil-shaped beam former. FIGS. 7c-d are simulated (FIG. 7c) and experimentally measured (FIG. 7d) far-field properties of the airfoil device. The far-field profiles were calculated using near-to-far-field transformations from the scattering near-field profiles. FIG. 7e shows measured electric near-field profiles at three different frequencies. The antenna position is marked by the black circle.

Experimental field scans of the device as a function of antenna frequency show excellent agreement between theory and such successful experimental examples. A comparison of the far-field power distribution as a function of frequency, obtained using a near-to-far field transformation of the scanned fields, shows highly efficient beam deflection to the desired angle in a manner that matches theoretical far-field predictions (FIGS. 7c and 7d). The ability of such a device to perform beam steering from −20° to +20° with only a 10% change in frequency showcases the potential of the platform to support strong super-prism-like effects in a manner that is decoupled from the device's form factor. The divergence of the collimated beams is 8.0° at the central frequency, which corresponds to an aperture of 240 mm that matches the device width. As such, the extreme non-local light-matter interactions manifested in the metamaterial can enable aperture-limited beam forming despite the point nature of the source and the unusual shape of the device. Representative near field distributions at three different frequencies (FIG. 7e) show clear collimation directed towards the intended target direction. Simulated near-field distributions as the frequency may be observed as the frequency is continuously swept from 10 to 12 GHz (as generally depicted from left to right in FIG. 7e which, in color, show upward radiation in alternating waves of red (MAX) and blue (−MAX)).

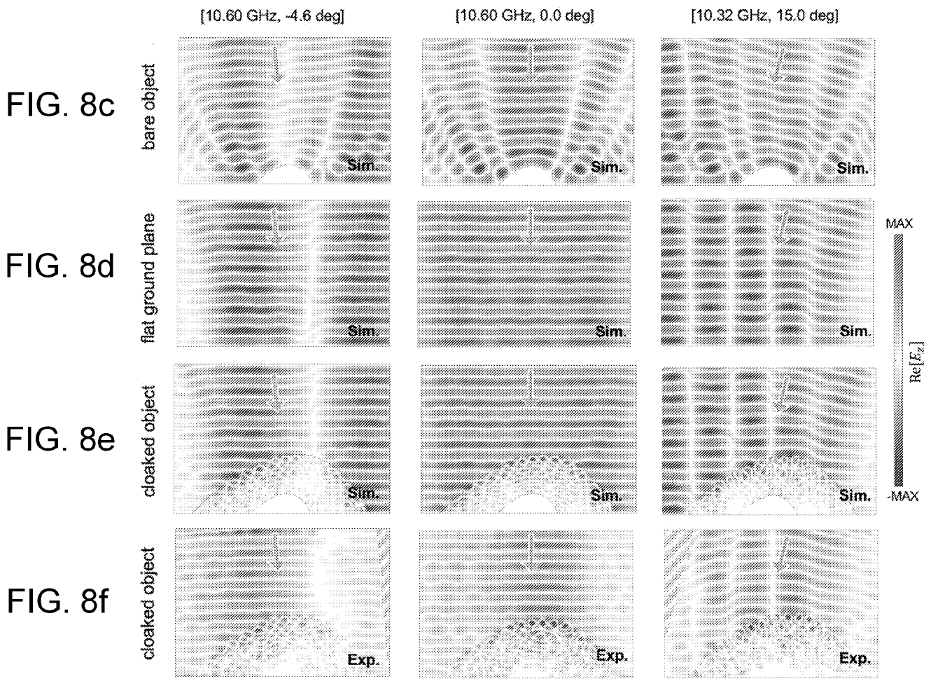

Finally, these efforts experimentally demonstrate a compact invisibility carpet cloak, as in FIGS. 8a-8f, that is conformal to an arbitrarily shaped object. As with FIG. 7e, in color FIGS. 8a-8f show radiation in alternating waves of red (MAX) and blue (−MAX).

As shown in FIG. 8a and FIG. 8b, the optimized device has a two-wavelength-wide footprint, and it conformally covers an asymmetrically shaped object with a geometry represented by the Cubic Bezier spline. The grayscale carpet cloak renders the object invisible by restoring the phase of the reflected wave as to mimic the ground plane response, and it is responsive to incident waves featuring frequencies ranging from 10 to 11 GHz and incident angle ranging from −30° to +30°. This cloaking approach aims to address limitations posed by existing methods based on coordinate transformations, which require complex-valued permittivity and permeability parameters for implementation and are difficult to generalize to arbitrary shapes. It also aims to improve on existing carpet cloak concepts, which can introduce non-ideal phase shifts in the scattered light wave response.

More specifically, FIG. 8a is a design of a ground plane cloak that is conformal to an asymmetric, perfectly electrically conducting scatterer. The ground plane cloak specified to operate for incident angles spanning −30° to 30° and frequencies spanning 10 to 11 GHz. FIG. 8b is an image of the additively manufactured cloak and asymmetric curvilinear metallic scatterer with ground plane. FIGS. 8c-f show simulated near-field distributions of the bare scatterer with ground plane (FIGS. 8a-c), flat ground plane with no scatterer (FIGS. 8a-d), and scatterer with the conformal cloak (FIGS. 8a-e), and the experimental near-field distributions of the scatterer with the conformal cloak (FIG. 8f) agree well with the simulated results in (FIG. 8e). The figures include data for three different frequencies and/or incident angles, and the incident angles are denoted in the field plots by gray arrows. The hatched regions in (FIGS. 8a-f) are regions that were not scanned due to limitations in scanning area in the measurement apparatus.

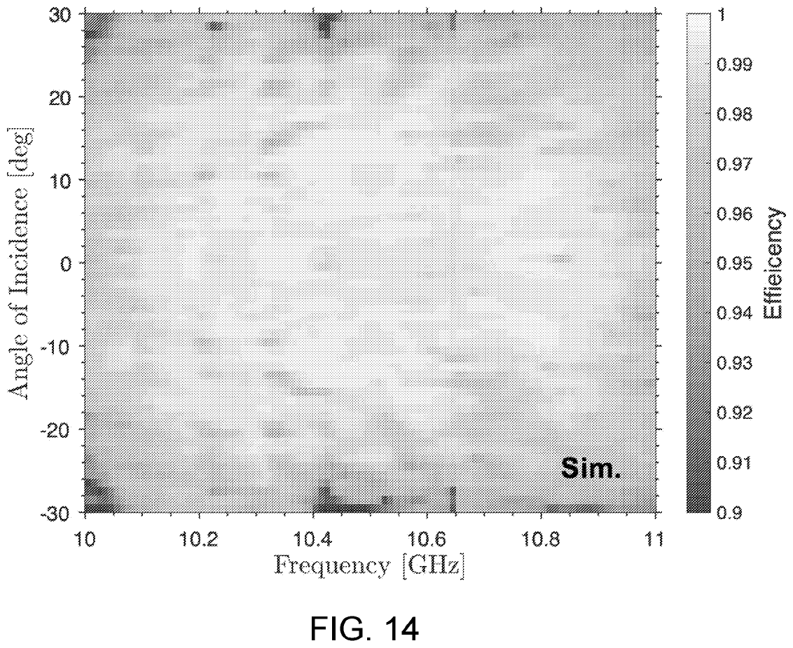

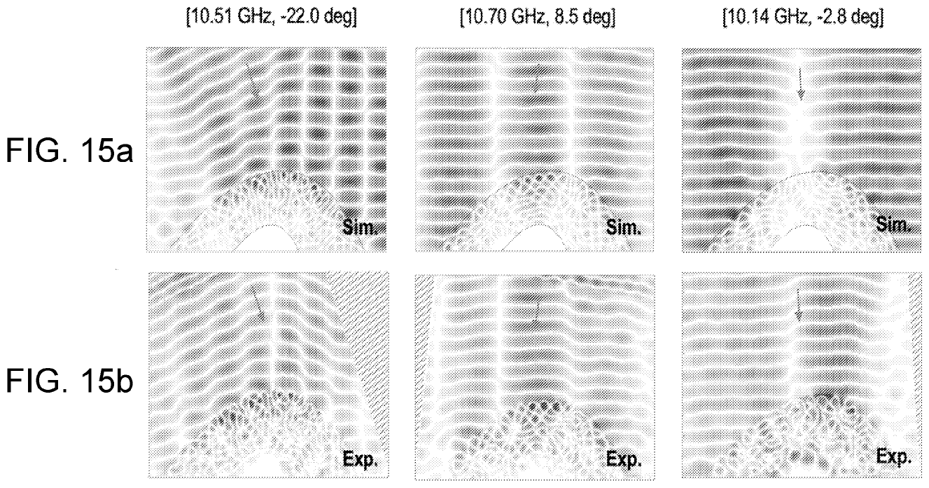

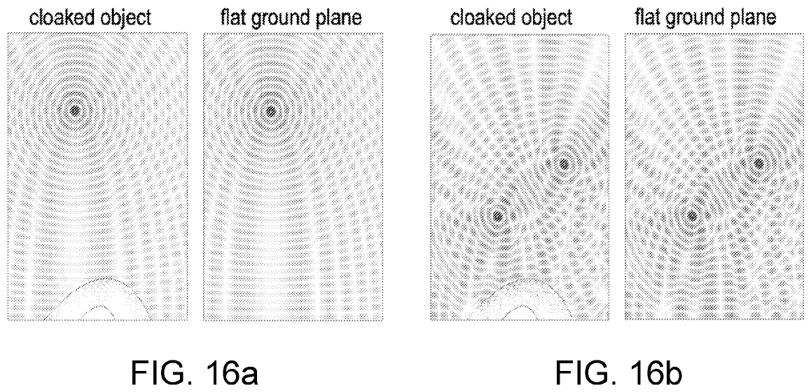

Theoretical field plots indicate that the optimized device exhibits excellent invisibility to planewaves as a function of frequency and angle of incidence (FIG. 14). Experimental scans of the cloak with a collimated incident beam, for different frequencies and angles of incidence, are summarized in FIGS. 8c-8f and show that the scattered field profiles match those of an incident wave reflecting from a flat ground plane. Furthermore, the simulated (FIG. 8e) and measured (FIG. 8f) field profiles are in excellent agreement. It is noted that as the subject device operates for a broad range of frequencies and angles, its invisibility functionality readily extends to incident sources with a diversity of temporal and spatial profiles, due to the linearity of Maxwell's equations. Accordingly, the device works well for a variety of incident Gaussian waveforms and can conceal the object from one or multiple point sources (FIGS. 15a-15b, FIGS. 16a-16b).

In summary, grayscale conformal metamaterials exhibit high efficiency, multiplexed optical responses as a function of wavelength and incidence angle. These experimental uses of high contrast grayscale dielectrics is essential to yielding design spaces that support exceptionally high performing devices, which can be identified using standard gradient-based optimization methods. Such experimental demonstrations of carpet cloaks and an airfoil-shaped beam former with wavelength-thick metamaterials indicate the potential for the platform to support advanced optical functionality with compact form factors. This type of grayscale metamaterials structure serves as ideal components for optical analog computing devices, communications, ranging, imaging, and sensing applications. They are particularly well suited for systems in which the optical hardware and software are co-designed to perform a specific task, as the gradient-based design method for the metamaterials can be readily integrated into end-to-end design algorithms based on backpropagation. While these experimental efforts focus on two-dimensional devices, the concepts can readily extend to three-dimensional electromagnetic systems, and emergent multi-material additive manufacturing techniques can lead to scaling of these concepts to large volumes and operating frequencies beyond the microwave. While an all-metamaterial approach is suitable for many applications, hybrid optical systems that synergistically combine grayscale metamaterials with refractive and scalar diffractive optics may be used to further enhance bandwidth, aberration correction, and/or functional multiplexing capabilities.

Supplementary Information. Supplementary Information for the above-discussed experimentation is presented hereinbelow in three sections, S1, S2 and S3. The first of these sections (S1) addresses materials characterization for certain specific experimental (e.g., proof of concept) example embodiments.

Materials characterization (S1). To ensure accurate device design, it is critical to characterize the electromagnetic properties of the printed material as extruded, which has imperfect infill density (i.e., contains small air voids between the extruded filaments) and therefore different electromagnetic properties than the homogeneous bulk filament material.

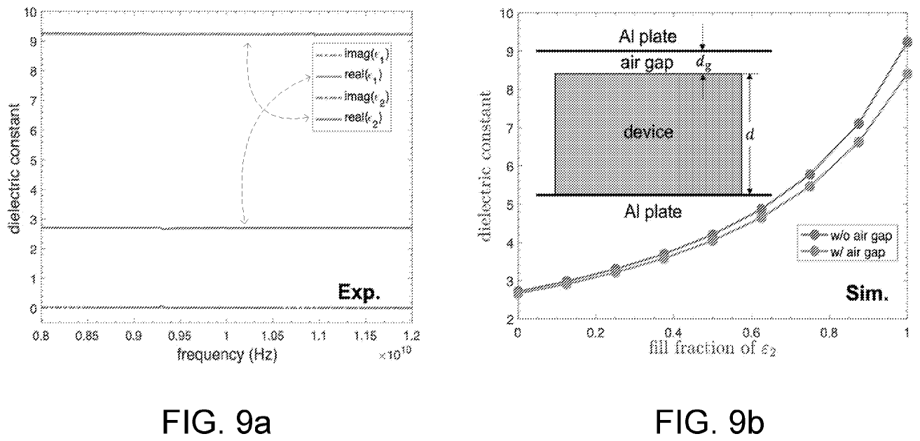

Two ceramic-embedded filaments (e.g., available from Preperm™ of Avon Lake, Ohio) are used in the experiments, ABS 300 and ABS 1200. The complex dielectric constants of the printed materials are characterized using the filled waveguide method. The measurement setup consists of a network analyzer (Rohde & Schwarz ZNB20), coaxial cables extending from the VNA ports to WR-90 waveguide adapters, and a 10-mm-long waveguide section filled with the printed block to be characterized. A thru-reflect-line (TRL) calibration is performed to obtain optimal results using a waveguide short as a reflect standard and a 10-mm-long waveguide “washer” as the line standard. Once the calibration is performed, all four S parameters of the filled waveguide are measured and then used the NRW algorithm to extract the complex dielectric constant from the S parameters. The extracted complex dielectric constants of the two filaments are plotted in FIG. 9a and show high dielectric constant contrast and extremely low loss across the X band.

The grayscale voxel is formed by vertically stacking thin film layers of the filament material, each with a thickness of 250 μm. Eight layers are used to produce a supercell with a thickness Λ=2 mm such that nine different fill fraction combinations, ranging from all ABS 300 to all ABS 1200, are considered. Five supercells are then vertically stacked to produce a 10 mm-tall voxel. Within each voxel, Λ<<λ and the layered media is squarely in the effective medium limit and away from the photonic crystal regime (Λ˜λ). Maxwell-Garnett effective medium theory (EMT) predicts that the multilayer effective dielectric constants with TE polarization (electric field polarized perpendicular to the layers) follow ε_{eff}⁻¹=fε₁⁻¹+(1−f)ε₂⁻¹, where f is the fill fraction of ε₁. The parallel plate waveguide enforces TE polarization in these experiments. The effective dielectric constants achievable in the voxels are shown as the upper curve (blue—without the air gap) in FIG. 9b.

In these experiments, a 120 μm air gap between the device and top aluminum plate provides space to enable smooth mechanical translation of the plates during scanning. As such, the guided electromagnetic wave within the parallel waveguide interacts with the 3D printed device plus this air gap. While the air gap is sufficiently thin as to not modify the mode distribution within the device, it does reduce the effective dielectric constant experienced by the guided wave. To account for this effect, an additional step of EMT is performed that accounts for the air gap, as shown with the arrow nearest the x axis (orange curve) in FIG. 10. The final minimum and maximum dielectric constants in this EMT limit are 2.67 and 8.40, respectively.

Optimization via an inverse design (S2). Discussion now turns to section S2, regarding an inverse design method used for optimization. In these efforts, two-dimensional dielectric structure designs are optimized to perform a set of optical scattering functions as a function of incident angle and frequency. The adjoint variable based optimization is adopted here to generate the grayscale dielectric constant distribution. The design domain is first discretized into irregular voxels using FEM mesh functions. Starting from an initial random grayscale distribution, an iterative calculation is made of the sensitivity of the device's Figure of Merit respective to its dielectric constant distribution, and then the dielectric constants are modified via gradient descent. The sensitivity is calculated from just two full-wave simulations per objective (using a product offering from COMSOL Multiphysics®), one forward and one adjoint simulation.

The Figure of Merit is defined as the inner product between the produced electric field and the target field at the device exit plane. To ensure a uniform Figure of Merit for the multi-objective functions, a series of frequency and angle of incidence points are randomly sampled in each iteration to calculate the sensitivity and update the device dielectric distribution.

After the optimization converges in the continuous dielectric constant domain, the dielectric constants are gradually pushed to nine discrete values specified in experiments using a multilevel sigmoid-like function. Reduction in the Figure of Merit is not noticeable with this discretization process.

Near field characterization of the metamaterial (S3). The next section, S3, concerns near field characterization of the subject metamaterial. Near field characterization of the metamaterial is performed in a 2D X-band parallel-plate waveguide consisting of two aluminum plates separated by a gap of h=10.12 mm. The VNA feeds the signal to the source and detects the S parameters data (S₂₁), which are stored as complex matrices and plotted as field maps in MATLAB. Two excitation methods are implemented for either a point source excitation or Gaussian beam excitation. For a point source excitation, which is used for the airfoil experiment, a coaxial probe on the lower plate excites a radial wave within the chamber. For a Gaussian beam excitation, which is used for the scatterer and cloaking experiments, radiation is introduced through a coaxial-to-waveguide adapter equipped on the edge of the lower plate and then collimated by a dielectric parabolic lens (FIG. 13a). The waveguide only supports the fundamental (TEM) mode. The measured field maps are stitched from three fixed probe antennas equipped on the top aluminum plates. The lower aluminum plate is attached to optical motion stages (available from Thorlabs, Inc.) that spatially translate the sample relative to the probe antennas. To avoid reflection from the boundary of the waveguides, a 10-mm-thick absorption foam is cut in a sawtooth pattern and arranged along the edges of the lower plate. Further details of the apparatus can be found elsewhere.

FIGS. 9a-9b illustrate experimentally realized dielectric constants for exemplary metamaterials, with FIG. 9a showing measured complex dielectric constants of two ceramic-embedded filaments constituting the metamaterial, and with FIG. 9b showing nine dielectric constant values achieved through the multilayer voxel architecture, calculated using effective medium theory. The upper (blue) curve in FIG. 9b considers only the device, and the lower (orange) curve considers the combination of the device and a small air gap between the device and the top aluminum plates. The inset shows a cross sectional schematic of the device within the parallel plate waveguide. In this particular example setup, d=10.00 mm and d_{g}=0.12 mm.

FIG. 10 illustrates a visualization of 100 grayscale grating patterns produced by topology optimization, depicted in a 2D representation of the design space constructed using principal components analysis. Individually optimized devices that present near-unity deflection efficiencies have very different device patterns, indicating that there are many high-quality local optima in the grayscale design space.

FIGS. 11a-11c show a comparison of two metagratings having dielectric contrasts of Δε=1 and Δε=10, respectively. FIG. 11a shows dielectric constant distributions. FIG. 11b shows the near fields distribution (As with previous figures such as FIGS. 7e, 8a-8f, in color FIG. 11b shows radiation in alternating waves of red (MAX) and blue (−MAX)). FIG. 11c shows the power flow. The colormap and arrows show the magnitude and direction of Poynting vectors, respectively.

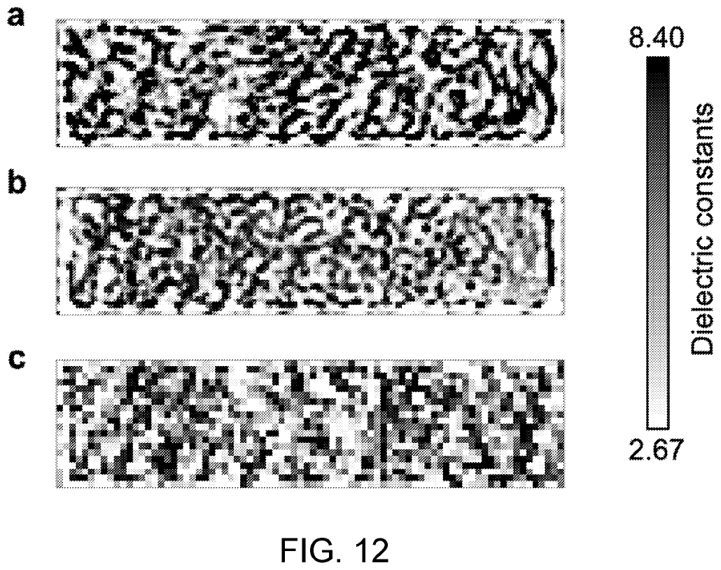

FIG. 12 shows a dielectric distribution of the three dispersion engineered devices shown in FIG. 6a-6c in the preceding text. The device footprint is 24 mm by 6 mm.

FIGS. 13a-13b. Effect of deviation of the incidence beam from a planewave. FIG. 13a shows an experimental setup to generate Gaussian beam incident wave. The excitation wave emanating from the coaxial-to-waveguide adapter is collimated by a dielectric lens. Due to the finite size of the collimating lens and the presence of the absorption foam, the incident beam has a finite beam width. The deviation of the incident beam from an ideal planewave, which is used in simulations, is responsible for the slight difference in field distributions between experiments and simulation. FIG. 13b shows the electric fields distribution for the device in FIG. 6h in the preceding text when considering the collimating lens instead of planewave excitation (as previously in color FIG. 13b shows radiation in alternating waves of red and blue). The simulated fields inside the metamaterial are more consistent with the experimentally measured fields in FIG. 6g in the preceding text.

FIG. 14 shows the simulated Figure of Merit of the cloak under planewave incidence as a function of angle of incidence (from −30° to 30°) and frequency (from 10.00 to 11.00 GHz). The Figure of Merit of the cloak is defined as the inner product of two electric fields at the exit plane, one with the cloaked object and the other with only the flat ground plane. The cloak presents extremely high Figure of Merits across the entire wide angular range and bandwidth.

FIGS. 15a-15b shows the experimental ground cloak under more incident directions and frequencies with FIG. 15a showing the simulated and FIG. 15b showing experimentally measured electric fields distribution of the cloaked object. In color FIG. 13b shows radiation in alternating waves of red and blue.

FIG. 16a-16b show the carpet cloak illuminated with point excitation sources. Electric field distribution of the cloaked object and corresponding flat ground plane response given (FIG. 16a) a single out-of-plane antenna probe source and (FIG. 16b) two out-of-plane antenna probe sources are shown. The cloaked fields are in excellent agreement with the target fields generated by a flat ground plane. Again, in color radiation patterns are shown in alternating waves of red and blue.

In other observations of these experiments (not illustrated herein), the efforts simulated near fields distribution of the air-foil shaped beam former as the frequency is swept from 10 to 12 GHz. Also, these efforts include a side-by-side comparison of the simulated near-field distributions of the cloaked object and a flat ground plane for incident planewaves of varying frequency and angles of incidence. In the first half of a recording (not illustrated herein), the frequency is fixed at 10.6 GHz and the angle of incidence is swept from −30° to 6°. In the second half of the recording, the angle of incidence is fixed at 6° and the frequency is swept from 10.6 GHz to 10.0 GHz.

It is recognized and appreciated that as specific examples, the above-characterized figures and discussion are provided to help illustrate certain aspects (and advantages in some instances) which may be used in the manufacture of such structures and devices. These structures and devices include the exemplary structures and devices described in connection with each of the figures as well as other devices, as each such described embodiment has one or more related aspects which may be modified and/or combined with the other such devices and examples as described hereinabove may also be found in the above-referenced U.S. Provisional Application and including the references cited therein.

The skilled artisan would also recognize various terminology as used in the present disclosure by way of their plain meaning. As examples, the Specification may describe and/or illustrates aspects useful for implementing the examples by way of various semiconductor materials/circuits which may be illustrated as or using terms such as layers, blocks, modules, device, system, unit, controller, and/or other circuit-type depictions. Also, in connection with such descriptions, the term “source” may refer to source and/or drain interchangeably in the case of a transistor structure. Such semiconductor and/or semiconductive materials (including portions of semiconductor structure) and circuit elements and/or related circuitry may be used together with other elements to exemplify how certain examples may be carried out in the form or structures, steps, functions, operations, activities, etc. It would also be appreciated that terms to exemplify orientation, such as upper/lower, left/right, top/bottom and above/below, may be used herein to refer to relative positions of elements as shown in the figures. It should be understood that the terminology is used for notational convenience only and that in actual use the disclosed structures may be oriented different from the orientation shown in the figures. Thus, the terms should not be construed in a limiting manner.

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. Such modifications do not depart from the true spirit and scope of various aspects of the disclosure, including aspects set forth in the claims.

1. An apparatus comprising:
a three-dimensional metamaterial, including alternating layers of different respective materials which collectively correspond to a grayscale dielectric profile for producing a certain electromagnetic response.

2. The apparatus of claim 1, wherein the three-dimensional metamaterial is to approximate a grayscale continuum of dielectric constants.

3. The apparatus of claim 1, further including an electromagnetic device having a curved shape, wherein the three-dimensional metamaterial is to conform to the curved shape.

4. The apparatus of claim 1, further including an electromagnetic device to operate via communication of radiating waves, wherein the three-dimensional metamaterial is part of the electromagnetic device and is to steer the radiating waves as a function of frequency.

5. The apparatus of claim 1, wherein the three-dimensional metamaterial includes substructures, as cells or voxels, which have irregular shapes to provide a continuum of dielectric values, with each of the substructures being associated with a permittivity appearing different for different incident light polarizations.

6. The apparatus of claim 1, wherein the three-dimensional metamaterial is to control and direct electromagnetic waves in at least one of a microwave frequency range and a millimeter wave frequency range, and the three-dimensional metamaterial includes light-cured resin characterized as having at least one of: ceramic nanoparticles to set a part of the three-dimensional metamaterial for producing the certain electromagnetic response; varying cross-linking densities; and being configured to boost dielectric constant properties.

7. The apparatus of claim 1, wherein the three-dimensional metamaterial is to control and direct, without relying upon a resonator, electromagnetic waves in at least one of a microwave frequency range and a millimeter wave frequency range.

8. The apparatus of claim 1, further including at least one of: one or more antenna arrangements including multiple co-frequency antennas cooperatively arranged with the three-dimensional metamaterial; and an electromagnetic antenna array arranged in a curved shape, wherein the three-dimensional metamaterial is to conform to the curved shape and to act as a multifunctional lens to project antenna radiation from elements of the electromagnetic antenna array into respective different angles of field of view.

9. The apparatus of claim 1, wherein the three-dimensional metamaterial is part of an interconnect to support multiple waveguide transmission modes.

10. The apparatus of claim 1, wherein the three-dimensional metamaterial is part of a filter or multiplexer circuit to operate based on dielectric resonance modes and/or to support disparate (or arbitrary) frequency-multiplexed functions.

11. The apparatus of claim 1, wherein the three-dimensional metamaterial is part or result of a manufacturing system that is to produce volumetric metamaterials using an additive process to create the three-dimensional metamaterial based on an inversion design.

12. The apparatus of claim 1, wherein the three-dimensional metamaterial includes multiple filament materials additively arranged to approximate a grayscale continuum of dielectric constants.

13. The apparatus of claim 1, wherein the three-dimensional metamaterial includes multiple filament materials, corresponding to the different respective materials, which are to approximate a grayscale continuum of dielectric constants, and wherein the multiple filament materials are arranged in multiple thin-film layers with the multiple thin-film layers having a first type of layer characterized by a first type of material and having a second type of layer characterized by a second type of material, and wherein electromagnetic fields associated with the certain electromagnetic response, experience an effective dielectric constant whose value is in a range having boundaries corresponding to dielectric constants respectively associated with the first type of material and the second type of material.

14. The apparatus of claim 1, wherein the three-dimensional metamaterial includes a shaped thin-film dielectric grayscale metamaterial over certain portions of an antenna structure, and the shaped thin-film dielectric grayscale metamaterial is to affect spatial and polarization control provided by the antenna structure.

15. The apparatus of claim 1, wherein the three-dimensional metamaterial is characterized via substructures as cells or voxels, each of the substructures being associated with at least one of a plurality of incident light polarizations and at least one dielectric constant distribution for accommodating a phase shift of said at least one of a plurality of incident light polarizations.

16. The apparatus of claim 1, wherein the three-dimensional metamaterial is to conform to a surface, which is nonlinearly or irregularly-shaped, of substrate material and is to cloak at least a portion of the surface and render said at least a portion of the surface as appearing invisible.

17. The apparatus of claim 1, wherein the three-dimensional metamaterial is extendible to an arbitrary geometry and is to correct for aberration and shape electromagnetic wavefronts as a function of at least one of polarization, incident angle, and wavelength.

18. A method comprising:
producing or accessing a grayscale dielectric profile associated with a certain electromagnetic response; and
via the grayscale dielectric profile, providing a three-dimensional metamaterial including a set of alternating layers of different respective materials which collectively correspond to the certain electromagnetic response.

19. The method of claim 18, wherein producing or accessing a grayscale dielectric profile includes using an algorithm, involving topology optimization or an inversion design, to create the grayscale dielectric profile for the certain electromagnetic response, and wherein providing a three-dimensional metamaterial corresponding to the certain electromagnetic response includes using an additive process to form the three-dimensional metamaterial.

20. The method of claim 18, further including using the three-dimensional metamaterial to provide multiple electromagnetic modes of operation, and wherein providing a three-dimensional metamaterial corresponding to the certain electromagnetic response includes using an additive process in which sets of multiple filaments, having dielectric constants of at least 15, are accumulated to form the three-dimensional metamaterial.

21-28. (canceled)
